(19) United States
(12) Patent Application Publication
(10) Pub. No.: US 2016/0288254 A1
(43) Pub. Date: Oct. 6, 2016

(54) APPARATUS AND METHOD FOR PRECISION THERMAL PROCESSING OF A BODY

(71) Applicants: Richard G. Pettit, Fruit Heights, UT (US); Michael D. Marotta, Beaverton, OR (US)

(72) Inventors: Richard G. Pettit, Fruit Heights, UT (US); Michael D. Marotta, Beaverton, OR (US)

(73) Assignee: FractureLab, LLC, Fruit Heights, UT (US)

(21) Appl. No.: 14/679,940

(22) Filed: Apr. 6, 2015

(51) Int. Cl. B23K 26/064; B23K 26/073; G02B 27/42; B23K 26/342; B23K 15/00; B23K 15/02; B23K 26/06; B23K 26/082

(52) U.S. Cl. CPC B23K 26/064; B23K 26/0626; B23K 26/0732; B23K 26/082; B23K 26/342; B23K 15/0086; B23K 15/02; G02B 27/4233; B33Y 10/00

(57) ABSTRACT

The invention pertains to apparatus and method for precision thermal processing of a body. An energy beam emanating from an energy beam source is scanned across the surface of the body, creating heat input through a moving spot on the surface of said body. By means described herein to condition the spot shape and flux profile, the flux profile within the spot is configured to approximate a thermal solution obtained by solving a boundary condition of the third kind imposed upon the moving spot associated with the beam as it is scanned across the body. In this manner a predetermined surface temperature profile is imposed on the surface of the body within a moving, locally heated spot of predetermined shape and size.

Potential uses include any application which would benefit from the ability to apply a prescribed uniform or variable thermal process to the surface of a body, thus including but not limited to thermal processing of inorganic materials, such as metals and ceramics, and thermal processing of polymeric or organic materials or tissues. Exemplary desired outcomes range from an improvement of surface properties, such as hardness or wear resistance, to the fabrication of a component through an additive manufacturing process.

### CROSS-REFERENCE TO RELATED APPLICATIONS

Not Applicable.

### BACKGROUND OF THE INVENTION

1. Field of the Invention

The invention pertains to an apparatus and method for precision thermal processing of a body with an energy beam such as a laser or an electron beam. Potential uses include any application which would benefit from the ability to apply a prescribed uniform or variable thermal process to the surface of a body, thus including but not limited to thermal processing of inorganic materials, such as metals and ceramics, and thermal processing of polymeric or organic materials or tissues. Exemplary desired outcomes range from an improvement of surface properties, such as hardness or wear resistance, to the fabrication of a component through an additive manufacturing process. While prior art can already perform many of these tasks after a sort, the proposed technology is distinguished by a degree of precision with which the thermal process can be carried out, thus rendering the process more stable and uniform, potentially more rapid and enabling beneficial outcomes unattainable by less precise means.

Many potential applications will be apparent to one skilled in the art in light of the description of exemplary embodiments that will be given hereafter.

2. Description of the Prior Art

Energy beams, such as laser or electron beam are broadly used as a heat source in in many industries, and are finding new applications at an accelerating rate. Generally, applications require a degree of control over the amount and distribution of beam energy used in the process to achieve a predetermined outcome. Too much or too little energy imparted to the process can negatively impact process quality. Typical process control methods most commonly involve prescribing external parameters such as the beam power, spot size and shape, and a feed rate of the spot relative to the work piece where applicable. These settings may be determined based on operator experience or empirical evidence. However, when attempting to apply the same process to parts of different geometry, the actual temperature history resulting from a process so prescribed will in fact vary, with potential for process failure or poor quality.

One attempt to address this kind of process variability has been to employ closed-loop control of the beam power, exposure time or feed rate to maintain a prescribed local surface temperature, as measured by a pyrometer or other means. U.S. Pat. No. 4,317,981 is an early example of this is approach.

U.S. patent application Ser. No. 14/293,537 describes another feedback-based approach that measures the reflected power, and thereby infers and controls the absorbed power imparted to the body to a predetermined rate.

A sophisticated system to track the melt-pool size, shape, and temperature for an additive manufacturing application is described in US Patent Office Publication 2014/0163717 A1. This recent work is of particular interest because the object of the invention includes achieving Scanning Laser Epitaxy (SLE), an additive manufacturing concept that in principle could be used for the repair or solid printing of single crystal turbine blades from nickel superalloy powders. While additively manufactured metal parts typically exhibit a degree of epitaxial character within the layered microstructure, the object of SLE is to extend an existing single crystal additively without creating any stray (misoriented) grains—a process that is expected to require a precisely controlled thermal process.

While the melt-pool tracking feedback system is credited with improving process quality, photographs of sample single-layer SLE deposits shown in the publication and the author's website (http://ddm.me.gatech.edu/page8/page8.html—see FIG. 8) show a large region of fairly epitaxial single crystal extension, but with numerous internal stray grains and an outer skin of polycrystalline microstructure. The internal stray grains are fairly small, and the outer skin could potentially be machined off for a single-layer repair application, or be remelted on the next pass for a multi-layer build. However, while a few internal stray grains sufficiently small might be tolerable in a single-layer repair application, any one of these could seed much larger stray grains in the next layer of a more extensive repair, or in the solid printing of an entire part. Because grain boundaries are very weak in these materials, such parts would be unacceptable.

U.S. Pat. No. 6,046,426 and U.S. Pat. No. 4,863,538 describe powder jet and powder bed type additive manufacturing processes.

A shortcoming in such processes not addressed by feedback systems is the thermal distribution within the beam spot itself. The thermal profile on the surface of a body resulting from the passage of a scanning a typical Gaussian or even flat-topped beam is not uniform. In a one-pass process, for example, a path along the surface is treated, but the center of the path experiences a much higher temperature excursion than the outside edges of the path, and very different heating and cooling rates.

### SUMMARY OF THE INVENTION

The invention encompasses an apparatus and method for precision thermal processing of a body or workpiece using an energy beam. An exemplary embodiment includes an energy beam source, a means to scan the beam across the surface of the body thereby creating heat input through a moving spot on the surface of the body. Also included is a means to condition the spot shape and flux profile where the beam is incident on the surface of the body.

While the beam source and scanning system may be selected without restriction from existing art, the flux profile has novel and distinguishing characteristics that are manifest in the apparatus and process.

The flux profile within the spot is configured to approximate a thermal solution obtained by solving a boundary condition of the third kind imposed upon the moving spot associated with the beam as it is scanned across the body. By convention, a thermal boundary condition of the third kind occurs when the temperature is specified across a specified boundary—in this case, at least a portion of the surface within the domain of the spot.

The specified temperature may be specified as constant within the spot, or vary according to a predetermined thermal profile spatially and/or temporally.

Aside from the thermal boundary condition of third kind within the moving spot, boundary conditions elsewhere on the body may be specified to match or approximate the geometry of the body and the processing conditions.

The thermal solution can be solved by any means known in the art without restriction, including finite element, closed-form theoretical expressions, or hybrid schemes.

The thermal solution is construed here to include the effects of the reflectivity of the surface associated with the incident beam, unless the beam power is sufficiently compensated for the reflected portion of the beam, using means similar in function to U.S. patent application Ser. No. 14/293,537 described earlier.

Where appropriate, the thermal solution may also include complex phenomena, including but not limited to material properties that vary spatially (as with functionally graded materials) or with temperature, melting, convection and the effect of surface tension within the melt zone. The body may also include a portion of material that is not yet consolidated, or is in the process of consolidation, as in an additive manufacturing process, that may be accounted for in the model.

The output of the thermal solution includes the flux profile that must be applied by the energy beam to the spot surface to create the temperature profile specified in the boundary condition of the third kind. Depending on the imposed temperature profile and the geometry, the required flux profile can be time-independent, or may vary with time. In practice this flux profile will be approximated, and the fidelity of the applied flux profile will influence the fidelity of the resulting thermal profile. The means chosen by the practitioner for conditioning the spot shape and flux profile will reflect a balance between system cost and the thermal fidelity. Various exemplary means will be discussed later on.

The local heating and cooling rate of the surface in the vicinity of the spot can be controlled approximately by judicious choice of the scanning velocity. An increase in scanning velocity increases the local heating and cooling rates both within and without the spot. Within the spot, where controlled by the boundary condition of the third kind, high precision heating and cooling rates can be imposed in this manner. In the surrounding vicinity, the heating and cooling rates are less tightly controlled but may still be afforded a similar level of control to the prior art by the choice of scan rate.

In this connection, it is useful to configure the spot shape to be rectangular, and to move the spot along an axis substantially parallel to one of the edges of the rectangle as the beam scans across the body. This creates a situation where a line segment of surface points enters the spot domain simultaneously through the leading edge of the rectangle, and leaves the spot simultaneously at the trailing edge, thus receiving the same amount of time exposure within the spot. “Substantially parallel” in this sense allows for minor angular deviations, allowing the scan path to be curvilinear, or otherwise accommodate the geometry of the body being processed.

It is useful to further specify the surface temperature profile within the spot to be constant along the direction normal to the axis of movement, thereby imparting substantially the same temperature vs time profile to each point within a set of points entering the leading edge of the spot simultaneously, within the time interval while the spot passes over them.

Further, by moving the spot at a constant velocity, with the temperature profile within the spot specified to be time-independent, a substantially uniform temperature vs time profile is applied to that portion of the surface so treated. This overcomes a primary weakness of the prior art discussed previously.

By way of example, but without restriction, a useful spot temperature profile may be configured to include such features as a hold or dwell period at a specified target temperature, and/or a temperature ramp, where the temperature changes at a specified rate. The target dwell temperature might be a melt or consolidation temperature for added manufacturing, or the desired initial condition preceding a quench for a surface hardening process. A chosen spatial thermal ramp within the spot, used in concert with a predetermined spot velocity, results in a temperature vs time ramp, which can be configured to a desired cooling or quench rate. For many materials and processes, the max temperature and the cooling rate are among the most critical parameters affecting the quality of the end product.

This is generally true in additive manufacturing operations, where the body includes a portion of material that is not yet consolidated, or is in the process of being consolidated to the remainder of the body.

It is especially true for processes like Scanning Laser Epitaxy (SLE) or electron beam epitaxy, where a portion of the body is substantially of a single-crystal, and the material being consolidated is being consolidated epitaxially to build up the single crystal. As mentioned earlier, recent prior art, even when performed by highly skilled practitioner, has been unable to maintain the level of thermal control necessary to additively manufacture quality multi-layer single-crystal nickel superalloy parts or repairs, and even single-layer deposits do not achieve the desired level of quality for repairs.

It is anticipated that the additional thermal control associated with the apparatus and process outlined herein will enable high quality additive manufacturing for fabrication or repair of single-crystal parts, such as turbine blades for gas-turbine engines.

For conventional single-crystal parts or repairs, straight, parallel primary dendrite growth is typically desired. However, for single-crystal or polycrystalline configurations, zig-zag, spiral, or other non-linear dendrite configurations are also potentially useful. Since the dendritic structure is a vestigial manifestation of preferential solidification behavior along specific crystalline axes, dendritic nonlinearity, such as in cold-worked metals, is often associated with high dislocation densities within the material.

It is well known that many metallic materials cannot achieve full mechanical properties without cold work. While dislocations may only be one result of cold work, it is apparent that some materials could benefit from processing that grows nonlinear dendrites by design, especially for near-net-shape applications where cold work is not practical. While no method exists in the prior art to achieve this in current casting technology, it is observed that during solidification, dendrites tend to grow parallel to the thermal gradient from cold to hot.

As an example of how micro-scale non-linear dendrite growth may be achieved, consider an apparatus for the precision thermal processing of a body as described above, but wherein the flux profile is further configured by superposing upon it a substantially periodic flux pattern of substantially zero net flux, thereby creating a periodic flux locally, while substantially retaining the original character of flux profile macroscopically. The periodic component of flux can be configured to move along with spot, or articulate spatially within the spot as the spot scans across the surface. This will result in a temperature profile substantially like that specified in the boundary condition of the third kind, but with a periodic pattern of slightly hotter and cooler subregions within the spot passing by the dendrites as they form, thus deflecting their growth in a periodic manner. It is also useful to configure periodic flux pattern to have a period length of a scale comparable in magnitude to the to the expected primary dendrite spacing of the processed material, thus promoting uniform processing of the dendrites.

Applications of non-linear dendrite processing in this manner could include use as a surface treatment, somewhat analogous to cold working processes like shot peening, or in an additive manufacturing process where the non-linear dendrite processing could be distributed through the part being manufactured either uniformly, or in a predetermined manner such as a functionally graded part.

Having discussed the nature of various configurations of the flux profile within the spot and their use in various exemplary applications, we now direct our attention to exemplary means by which such flux profiles may be achieved in practice.

In one embodiment, the means to condition the shape and flux profile of the spot is integrated with the means with the means to scan the beam. In this sense, the spot is construed to be in effect several times larger than the beam cross section, and the beam is rastered at high speed to create the effective spot shape and flux profile, while the effective spot created by the raster pattern scans over the surface at a lower speed.

A second means to condition the spot shape and flux profile includes an optical train configured to include at least one Diffractive Optical Element (DOE). A DOE can be configured to condition a laser beam with a circular cross section and Gaussian flux distribution, such as might exit the laser source, so that it irradiates a surface with a spot of predetermined shape and flux distribution. The remainder of the optical train may include other optical elements common to the art, including one or more of the following: a collimator, a variable beam expander, a mirror, a scanner, and a focusing lens. Scanning may also be effected by moving the workpiece or in any way that produces a relative motion between the workpiece and the beam.

For additive manufacturing applications, where the workpiece includes a portion of material that is not yet consolidated, or is in the process of being consolidated to the remainder of the body, it is useful to further configure the apparatus with a supply system for the unconsolidated material by which unconsolidated material is placed in the path of, or otherwise brought within the domain of the spot, where it is heated and consolidated by the energy beam.

A single DOE of fixed optical properties is useful for a substantially steady-state thermal processing configuration where the required flux profile within the moving spot is not required to vary with time during the process. For more complex processes, it is useful to configure the apparatus with an adaptive DOE that can alter the flux profile dynamically.

One device that can be used as an adaptive DOE is Spatial Light Modulator (SLM). This is a device with individually addressable pixels, kind of like a small computer screen. Available SLM devices are designed work in either reflection mode or transmission mode. When the beam is directed toward it, the screen can be programmed by way of an attached processor to display a changeable diffraction pattern configured to condition the beam to a dynamically changing flux profile.

Commercially available SLM devices available at this writing are currently limited to relatively low-power light transmission, but are expected to increase in capability over time as screens with larger active area are produced, and/or the permissible flux is increased.

An adaptive DOE can also be constructed using a multiplicity of DOE's, each configured to condition the beam to a predetermined spot flux distribution useful in the intended process. The optical train is further configured to include an optical manifold configured to switch the active element within the optical train between the DOE's, in this way approximating a dynamically changing flux profile.

Another adaptive DOE arrangement also includes a DOE with fixed optical properties. It is further configured with a moveable element to occlude or filter a portion of the beam by moving partially into its path. This is based on the observation that for the extreme case where an edge of the body is perfectly insulated, the flux profile for a spot moving along the edge in many cases has the appearance of half of the symmetric flux profile for the spot twice as wide moving along the surface well away from the edge. The edge spot profile in these cases would correspond to a 50 percent occlusion of a beam otherwise configured with the flux profile corresponding to a semi-infinite body. Other occlusion fractions could approximate edge flux profiles where the edges are not perfectly insulated, for example at the boundary of the consolidated and non-consolidated material in powder bed additive manufacturing applications. Further, in some applications instead of using a fully opaque element, a filtering element is useful. Also, more than one element may be used; for example, two occluding elements opposite each other, occluding the beam from either side, and thus truncating the spot from two sides, such as might be appropriate for thermally processing the surface on top of a thin wall.

Yet another adaptive DOE arrangement includes a DOE with fixed optical properties, designed to deliver a predetermined spot flux distribution when the element is placed at a nominal position within the optical train, with an input beam of nominal diameter. The DOE is mounted to an actuation system to articulate the element with respect to the nominal position to create variations in the spot flux profile. Useful articulation modes include, but are not limited to, movement perpendicular to the optical axis, movement along the optical axis, and rotation about the optical axis. Use of a variable beam expander to vary the input beam diameter provides additional beam shape variation. The range of variations so created are configured to approximate the flux distributions pertaining to the thermal solutions associated with the process.

To a large degree, the exemplary arrangements mentioned thus far are operable in open loop processes. However, it is useful to further arrange an embodiment to operate in closed loop by adding a temperature sensor and a feedback control system. Such a system can be configured to more tightly control the surface temperature within a portion of the spot by adjusting the total beam power to hold the measured temperature to a predetermined value. In this way the shape of the flux profile, and the corresponding temperature profile, are preserved, but the mean temperature is corrected by scaling the magnitude of the flux. The stability of the temperature measurement may also be enhanced by configuring the sensor to measure the average temperature over a portion of the spot that is configured to be nominally at constant temperature where applicable.

Many potential uses for the heating apparatus and method are thus encompassed in the present invention which include, but are not limited to those mentioned above.

In addition to the apparatus described above and hereafter, the invention encompasses the method for precision thermal processing described herein. In summary, the process includes first, selecting a predetermined surface temperature profile to impose on the surface of the body within a moving, locally heated spot of predetermined shape and size, which scans the surface of the body as it is being thermally processed; second, obtaining the required flux profile within the spot to achieve the predetermined surface temperature profile as the spot moves across the surface of the body from the solution of a thermal problem representing the body with a boundary condition of the third kind imposed within the spot; and third, heating the surface with the energy beam, wherein the beam is configured to the spot shape and flux profile as it scans across the surface of said body.

Further, the process includes use of all embodiments as described.

As can be seen, many other useful embodiments and applications of the precision thermal processing technology described could be devised by one skilled in the art.

### BRIEF DESCRIPTION OF THE DRAWINGS

The invention is described by way of example with reference to embodiments that are illustrated in the figures, but without thereby restricting the general object of the invention. Closely related figures have the same number, but different alphabetic suffixes.

FIG. 1 shows a schematic representation of an apparatus for precision thermal processing of a body with an energy beam.

A PRIOR ART figure, and FIGS. 2A, 2B, 2C, and 2D schematically illustrate various spot configurations associated with the energy beam, highlighting characteristics and advantages of exemplary embodiments over the prior art.

FIG. 3A shows a close-up representation of an optional, locally periodic variation of the flux profile, useful to promote non-linear dendrite growth as schematically illustrated in FIG. 3B.

FIG. 4 illustrates in four sequential frames the dynamic flux distribution obtained from the results of a thermal finite element analysis simulating thermal processing of a part with a spot configured to a boundary condition of the third kind similar to that shown in FIG. 2C.

FIG. 5A and FIG. 5B illustrate variants of the process illustrated in FIG. 4, but including unconsolidated material associated with exemplary additive manufacturing technologies.

FIG. 6 is a schematic illustration of a moving raster pattern by which the flux distribution for a rectangular spot can be approximated as it scans over a body

FIG. 7 is a schematic representation of an exemplary apparatus for precision thermal processing configured with a Diffractive Optical Element (DOE). Also shown is an optional delivery system for unconsolidated material for use in an additive manufacturing process.

FIGS. 8A and 8B respectively illustrate exemplary embodiments using transmission- and reflection-mode Spatial Light Modulators (SLM) as dynamic DOE to render dynamic flux profiles within the moving spot.

FIG. 9 illustrates an exemplary embodiment using a turret to switch between multiple DOE of different configurations to approximate a dynamic flux profile within the moving spot.

FIG. 10 illustrates an exemplary embodiment using a DOE and a movable occluding or filtering element to approximate a dynamic flux profile within the moving spot.

FIG. 11A-11C illustrate useful changes in flux profile associated with a DOE of fixed properties associated with deliberate deviations from nominal operating conditions with regard to beam alignment, input beam diameter, and focal distance respectively.

FIG. 12 illustrates an exemplary embodiment including a variable beam expander, and an articulating DOE to approximate a dynamic flux profile. Also configured with a feedback system using an infrared (IR) sensor.

FIG. 13 illustrates a process for precision thermal processing of a body with an energy beam.

### DESCRIPTION OF EXEMPLARY EMBODIMENTS

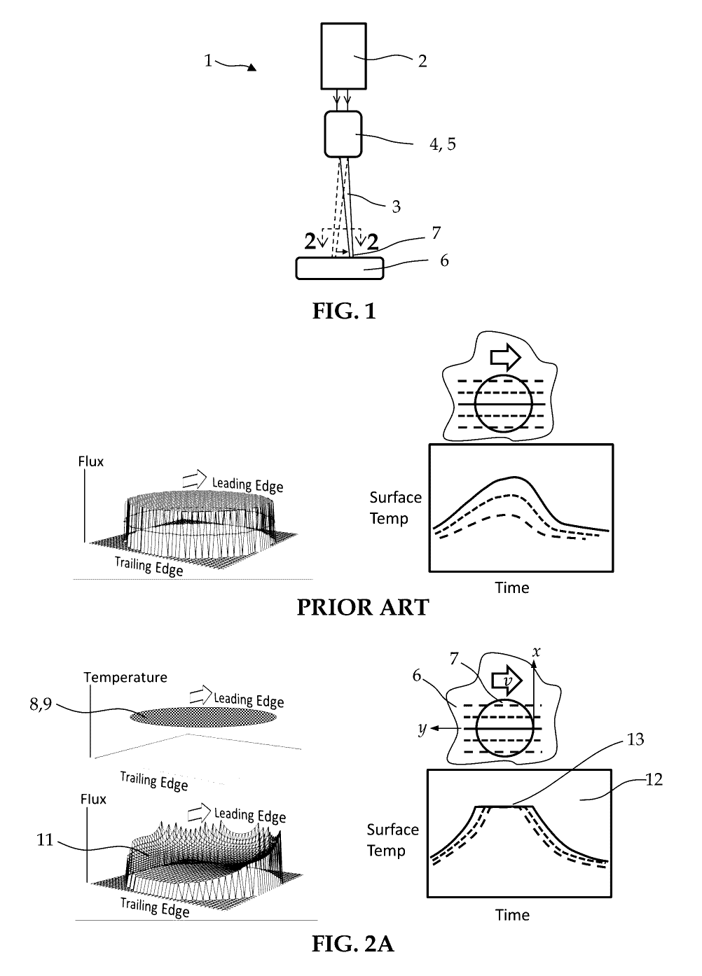

FIG. 1, shows a schematic representation of an apparatus 1 for precision thermal processing of a body 6. The exemplary embodiment includes an energy beam 3 emanating from an energy beam source 2, a means 4 to scan the beam 3 across the surface of the body 6, thereby creating heat input through a moving spot 7 on the surface of the body 6, and means 5 to condition the spot shape and flux profile. The means 4 to scan and the means 5 to condition the spot 7 are sometimes integrated as illustrated here, or may be embodied as separate and distinct means as will be described hereafter. While not shown, a computer or microprocessor is often required to operate many of the devices incorporated into this or other embodiments to be shown hereafter.

For the purposes of this exemplary embodiment, the beam source 2 and scanning system 4 may be selected without restriction from technology known to one skilled in the art. For example the beam source 2 may be a laser or an electron beam source. For an electron beam system, the beam may be focused and scanned by an integrated system of deflecting electromagnets. For a laser system, the scanner 4 may include one or more articulating mirrors or prisms, or an electro-optical or acousto-optical beam deflector. Other means of similar function are also contemplated.

It is in the nature of the flux distribution within the spot 7 that the current embodiment and the prior art are easily distinguished. The PRIOR ART figure illustrates the fact that as circular spot with flat-topped flux distribution moves across the surface of a body, the temperature vs time history experienced on the surface by material at the center and near the edge of the spot path differ considerably, and reach different maxima (note that the solid line in the plot corresponds to temperature at the center of the path, and the different dash configurations correspond to different positions within the path as shown in the legend above the plot). The same is true for other common spot configurations, including circular spots with a Gaussian or M-shaped flux profiles, and rectangular spots with flat-top profiles. Moreover, the relative differences in the thermal profiles across the spot path can vary considerably depending on the material properties, the size of the spot, and the spot velocity.

For the embodiments of FIGS. 2A-2C, the flux profile 11 within the spot 7 is configured to approximate a thermal solution obtained by solving a boundary condition of the third kind imposed within the moving spot 7. By convention, a thermal boundary condition of the third kind occurs when a temperature profile 8 is specified within a specified boundary. In our case, the boundary includes the surface area within the domain of the moving spot 7. In general, a thermal boundary condition of the third kind encompasses temperature profiles that can vary spatially and temporally so long as they are specified a priori. Aside from the thermal boundary condition of third kind within the moving spot 7, boundary conditions elsewhere on the body may be specified to match or approximate the geometry of the body 6 and the processing conditions.

Nevertheless, for the present discussion and without restriction, FIGS. 2A-2C may be considered to represent steady-state conditions where the spatial temperature profile 8 within the moving spot 7 does not change with time, and the flux profile 11 represents a steady-state condition such as would occur if the spot 7 were passing over a semi-infinite body. More general conditions will be shown later.

FIG. 2A is a representation of a circular spot 7 where the temperature profile 8 includes a region of uniform temperature 9 which fills the entire domain of the spot 7. The corresponding flux profile 11 is non-uniform, with high (asymptotically infinite) flux at the leading edge of the moving spot 7, and a finite flux at the trailing edge. While the profile 11 shown is representative, the shape and magnitude of the flux profile 11 required to match the specified temperature profile 8 will in practice vary with the applied surface temperature, the initial temperature, material thermal properties, spot size, and scanning velocity. The same is true of FIGS. 2B and 2C, which show spots 7 having rectangular shape, but different imposed temperature profiles 8, and resulting flux profiles 11. FIG. 2B depicts an isothermal spot 7, whereas FIG. 2C depicts a spot 7 with a hold temperature 9, followed by a temperature ramp, 10.

As mentioned earlier, the thermal solution can be obtained by any means known in the art without restriction, including finite element or other numerical schemes. For sufficiently simple geometries and boundary conditions, closed-form theoretical expressions may exist or be derived. Hybrid schemes employing more than one technique are also useful. In some cases, it is useful to obtain approximate expressions fitted to numerical solutions, generalizing them based on suitable dimensionless parameters.

For example, in the simple case where the body 6 of material being processed may be assumed to have thermal properties that do not vary with temperature, is large compared to the spot size, and if heat transfer by means other than conduction is negligible, the dimensionless flux profile φ̅(x, y) over the surface within the spot can expressed as a function of the dimensionless spot velocity υ̅ and the dimensionless temperature profile ΔT̅(x, y) within the spot 7

$$\overline{ϕ} = f ( \overline{v} , \overline{T} ) \\ Where , \\ \overline{ϕ} = \frac{( 1 - ρ ) ϕ d}{k Δ {T}_{0}} \overline{v} = \frac{vd}{α} Δ \overline{T} = \frac{Δ T}{Δ {T}_{0}} \qquad ( 1 )$$

Here, φ(x,y) is the incident flux profile 11, ρ is the reflectivity of the surface, k is the material thermal conductivity, ΔTₒ is the maximum temperature rise within the spot (relative to an initial background temperature of the body), υ is the velocity of the moving spot, d is a measure of the spot size (defined here to be its maximum dimension along the direction of spot movement), α is the thermal diffusivity, and ΔT(x,y) is the temperature profile 8 imposed within the spot 7 by way of a third-kind boundary condition. For purpose of discussion, the x-y Cartesian plane representing the spot surface moves with the spot 7, with the origin at the center of the leading edge, and the spot 7 moving in the −y direction, as indicated.

The flux profiles in FIGS. 2B-2C represent intermediate dimensionless velocities (υ̅=5). As υ̅ increases, the flux contour parallel to the x axis for these cases becomes increasingly flat, and the character of the flux profile shape becomes approximately 2D, as shown in FIG. 2D for the isothermal (ΔT̅=1) moving spot 7 similar to FIG. 2B, but at υ̅=100. As the spot velocity increases, the dimensionless flux profile for the isothermal rectangular spot 7 approaches

$$\overline{ϕ} = \sqrt{\frac{\overline{v}}{π y \text{/} d}} \qquad ( 2 )$$

The centroid of flux for this limiting profile lies at d/3, or one third of the spot dimension behind the spot leading edge. Rounding this value up to 40 percent, it provides a good upper bound for the flux centroid position for useful flux profiles over a wide range of dimensionless velocities down as low as υ̅≈0.05. Note that addition of a cooling ramp after a temperature hold will move the flux centroid even closer to the leading edge.

As indicated in Equation (1), the thermal solution is construed here to include the effects of the reflectivity of the surface associated with the incident beam. Note that if the beam power is sufficiently compensated for the reflected portion of the beam by means similar in function to U.S. patent application Ser. No. 14/293,537 as described earlier, the (1−ρ) factor may be omitted from Equation (1).

Where appropriate, the thermal solution may also include complex non-linear phenomena not included in Equation (1), including but not limited to material properties that vary spatially (as with functionally graded materials) or with temperature, melting, convection and the effect of surface tension within the melt zone. The body may also include a portion of material that is not yet consolidated, or is in the process of consolidation as in an additive manufacturing process, that may be accounted for in the model. Despite the fact that all these phenomena are not all included in Equation (1), the dimensionless parameters identified can still be useful to approximate the regime of operation.

The local heating and cooling rate of the surface in the vicinity of the spot can be controlled approximately by judicious choice of the scanning velocity. In practice, process outcomes can be sensitive to these rates, yet a high scanning velocity is desirable when possible to reduce process time. An increase in scanning velocity increases the local heating and cooling rates both within and without the spot. Within the spot 7, where controlled by the boundary condition of the third kind, high precision heating and cooling rates can be imposed as shown in FIGS. 2B and 2C. In the surrounding vicinity, the heating and cooling rates are less tightly controlled as shown but may still be afforded a similar level of control to the prior art by the choice of scanning velocity.

In this connection, it is useful to configure the spot shape to be rectangular, and to move the spot 7 along an axis substantially parallel to one of the edges of the rectangle as the beam scans across the body 6 as shown in FIGS. 2B and 2C. This creates a situation where a line segment of surface points enters the spot domain simultaneously through the leading edge of the rectangle, and leaves the spot 7 simultaneously at the trailing edge, thus receiving the same amount of time exposure within the spot 7. “Substantially parallel” in this sense allows for minor angular deviations, allowing the scan path to be curvilinear, or otherwise accommodate the geometry of the body 6 being processed.

FIGS. 2B and 2C also exhibit surface temperature profiles 8 within the spot 7 to be constant along the direction normal to the axis of movement, thereby imparting substantially the same temperature vs time profile 12 to each point within a set of points entering the leading edge of the spot 7 simultaneously, within the time interval while the spot 7 passes over them.

Further, by moving the spot 7 at a constant velocity, with the temperature profile 8 within the spot 7 specified to be time-independent, a substantially uniform temperature vs time profile 12 is applied to that portion of the surface so treated. This overcomes a primary weakness of the prior art discussed previously.

By way of example, but without restriction, FIGS. 2B and 2C illustrate useful spot temperature profiles 8 configured to include such features as a spatial hold 9 at a specified target temperature, and/or a spatial temperature ramp 10, where the temperature changes at a specified slope. For a given spot velocity, these translate into a temporal dwell 13 and a temporal thermal ramp 14 experienced by the surface material as the spot 7 passes over it. The target dwell temperature might serve, for example, as a melt or consolidation condition for additive manufacturing, or the desired initial condition preceding a quench for a surface hardening process. A chosen spatial thermal ramp 10 within the spot 7, used in concert with a predetermined spot velocity, results in a temperature vs time ramp 14, which can be configured to a desired cooling or quench rate. The cooling rate can be configured to be slower within the spot than the cooling rate trailing the spot associated with the scan velocity, thus enabling faster scan rates and reduce recurring cost compared to prior art processes.

For many materials and processes, the max temperature and the cooling rate are among the most critical parameters affecting the quality of the end product.

This is generally true in additive manufacturing operations, where the body 6 includes a portion of material that is not yet consolidated, or is in the process of being consolidated to the remainder of the body 6.

It is especially true for processes like Scanning Laser Epitaxy (SLE) or electron beam epitaxy, where a portion of the body 6 is substantially of a single-crystal, and the material being consolidated is being consolidated epitaxially to build up the single crystal. As mentioned earlier, recent prior art, even when performed by highly skilled practitioner, has been unable to maintain the level of thermal control necessary to additively manufacture quality multi-layer single-crystal nickel superalloy parts or repairs, and even single-layer deposits do not achieve the desired level of quality for repairs.

It is anticipated that the additional thermal control associated with the apparatus and process outlined herein will enable high quality additive manufacturing for fabrication or repair of single-crystal parts, such as turbine blades for gas-turbine engines.

As discussed previously, it is useful in some thermal processing applications to melt the material locally and grow microscale nonlinear dendrites as solidification takes place.

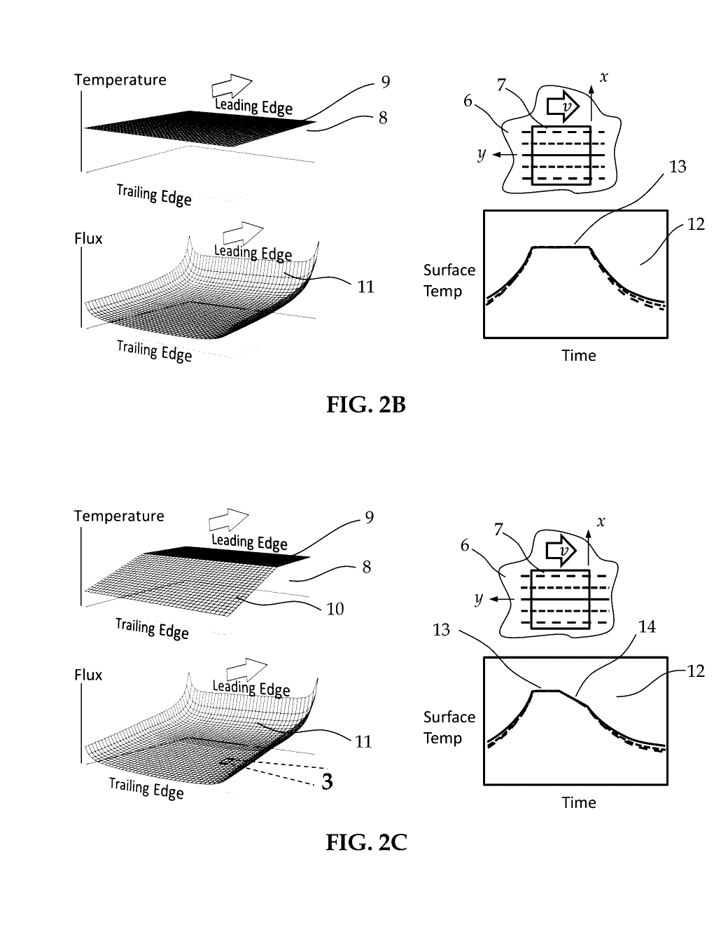

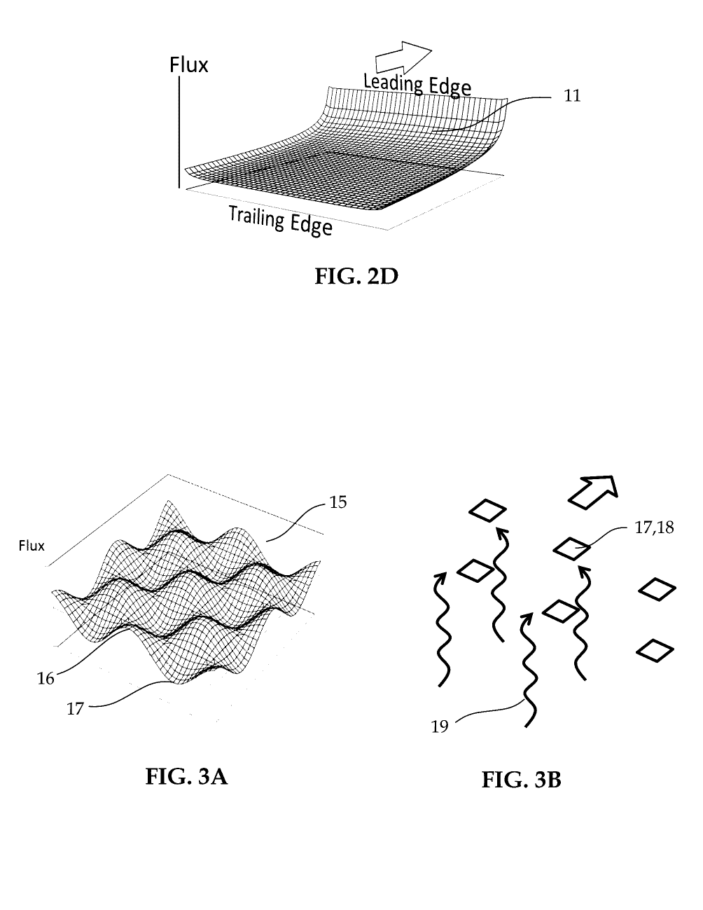

As an example of how micro-scale non-linear dendrite growth may be achieved, consider an apparatus for the precision thermal processing of a body as described above, but wherein the flux profile (for example that shown in FIG. 2C) is further configured by superposing upon it a substantially periodic flux pattern of substantially zero net flux. As illustrated in FIG. 3A this results in a periodic flux profile 15 locally, with local flux maxima 16 and minima 17, while substantially retaining the original character of flux profile macroscopically (as represented in FIG. 2C). The periodic component of flux is in this case configured to move along with spot, but can also articulate spatially within the spot as the spot scans across the surface. The resulting temperature profile is substantially like that specified in the boundary condition of the third kind, but as shown in FIG. 3B, with a periodic pattern of slightly cooler subregions 18 within the spot passing by the dendrites 19 as they form, thus deflecting their growth in a periodic manner. It is also useful to configure the periodic flux pattern 15 (FIG. 3A) to have a period length of a scale comparable in magnitude to the to the expected primary dendrite spacing of the processed material, thus promoting uniform processing of the dendrites 19.

Applications of non-linear dendrite processing in this manner could include use as a surface treatment, somewhat analogous to cold working processes like shot peening, or in an additive manufacturing process where the non-linear dendrite processing could be distributed through the part being manufactured either uniformly, or in a predetermined manner such as a functionally graded part.

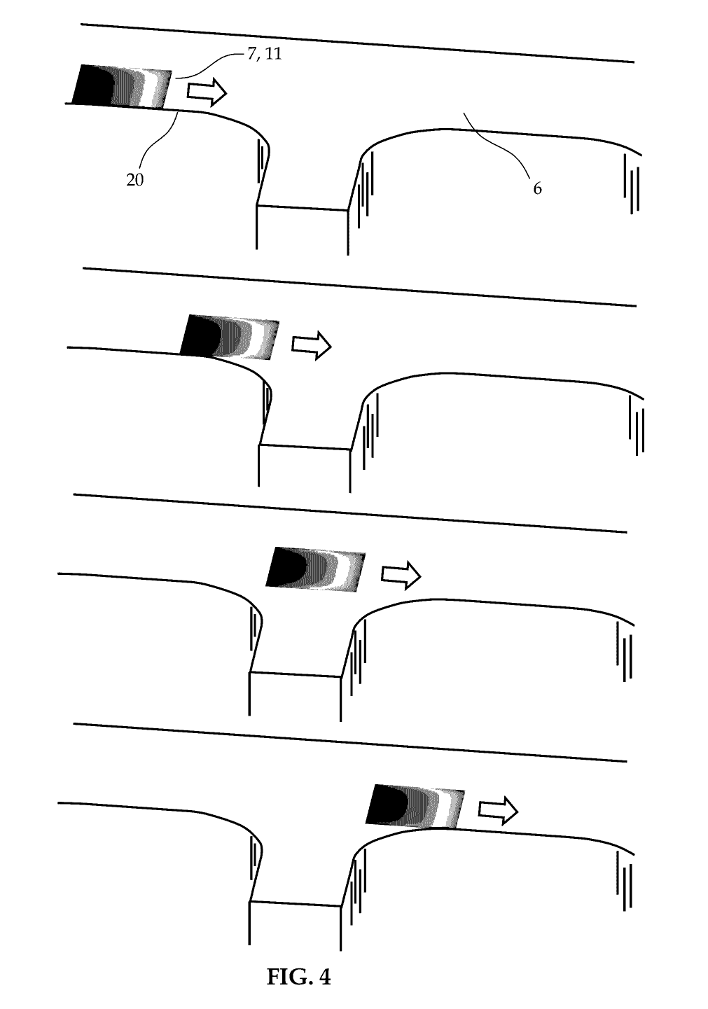

FIG. 4 schematically illustrates in four sequential frames (from top to bottom) the dynamic flux distribution obtained from the results of a thermal finite element analysis simulating thermal processing of a part with a spot 7 configured to a boundary condition of the third kind similar to that shown in FIG. 2C. However, in this case, instead of being remote from any geometric features, the spot 7 is scanned along a body 6 with an irregular edge 20. The flux profile 11 in this case (lighter shading represents higher flux within the spot) is seen to vary dynamically from half symmetry when the spot 7 is adjacent to the edge 20 (first frame) to full symmetry when the spot 7 was away from the edge 20 (third frame). This illustrates that geometric features close to the spot path can influence the flux profile 11 required to attain the specified temperature profile within the spot 7. A further observation, though not shown in the figure, is that the background temperature of the body 6 increases during the simulation as heat is added to the body 6, so when the spot 7 comes around again to scan neighboring surface material, the solution of the thermal problem, embodied by the simulation of the entire process, automatically reduces the magnitude of the flux profile 11 as required to keep the spot surface at the specified temperature profile.

Thus, as long as the spot path simulated is used during the actual process, and the dynamic flux profile 11 obtained from the analysis is faithfully applied to the body 6, the thermal process applied to the surface is independent of the path during the critical moments of the highest thermal excursion when the spot 7 passes over. This makes the process largely independent of the chosen scan path even for open-loop control. Also, the process sequence need be analyzed only once, and the solution can be stored and re-used to process multiple parts.

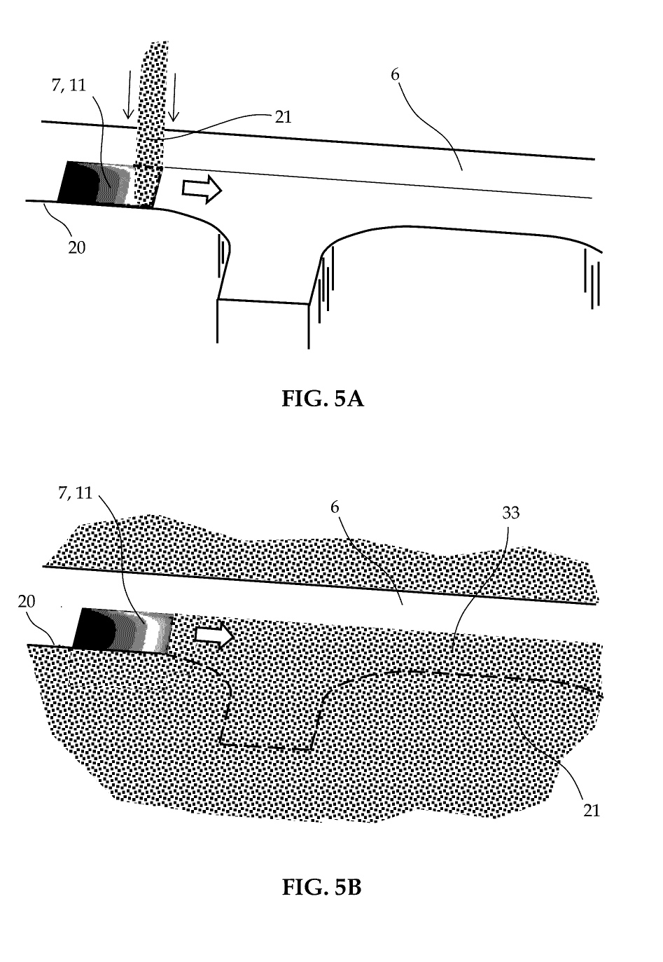

FIGS. 5A and 5B schematically illustrate precision thermal processes similar to FIG. 4, but integrated into otherwise existing additive manufacturing processes. In these figures the energy beam is not shown, to emphasize the spot flux distribution 11. FIG. 5A shows integration with a process similar to the well-known Laser Engineered Net Shaping (LENS) technology, which features an inert gas jet feeding powdered, unconsolidated material 21 from above to be consolidated as the part is built up layer-by layer from a build platform (not shown). In this embodiment, the jet is directed toward the forward end of the spot 7, where the flux profile 11 shows the highest flux concentration. Note that the spot 7 is shown adjacent to an edge 20, and thus has a flux profile 11 with the corresponding half-symmetry identified in FIG. 4.

FIG. 5B shows integration with an otherwise existing powder-bed process often referred to as selective laser melting when a laser is used. In this case, the unconsolidated powder 21 is rolled or raked out a thin layer 33, and selectively consolidated by the energy beam (not shown, but indicated by the resulting flux profile 11 within spot 7). Note that in this case, the flux profile 11 is somewhere between half and full symmetry, because the unconsolidated material 21 exhibits significant bulk thermal conductivity and thermal diffusivity, though less than the consolidated material.

Having discussed various exemplary embodiments and the nature of the corresponding flux profile within the spot, we now direct our attention to exemplary means by which such flux profiles may be achieved in practice.

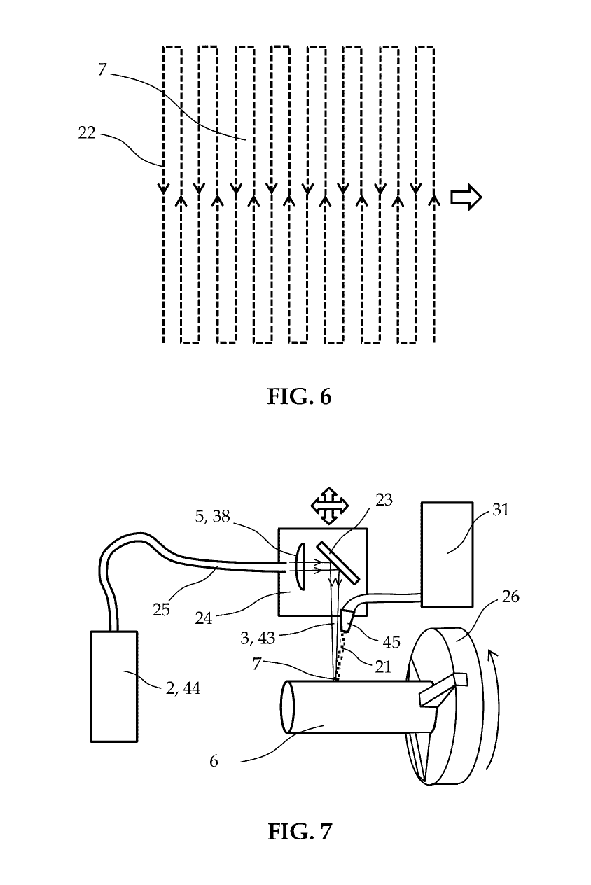

In an embodiment illustrated in FIG. 6, the means to condition the shape and flux profile of the spot 7 is integrated with the means to scan the energy beam (not shown in this Figure, see FIG. 1). In this sense, the spot 7 is construed to be in effect several times larger than the beam cross section, and the beam is rastered at high speed to create the effective spot shape and flux profile, while the effective spot 7 created by the raster pattern 22 moves over the surface at low speed. For the rectangular raster pattern 22 shown, the beam power is configured to vary as it scans to approximate the flux profile.

For the rastering speed to be sufficiently fast so that the flux laid down in one pass of the raster pattern approximates a steady flux profile within the spot 7, it is useful to configure the raster speed such that the time, Δtᵣₐₛₜₑᵣ associated with a single pass of the raster pattern conforms to the dimensionless ratio

$$\frac{d}{\sqrt{αΔ {t}_{raster}}} > 1 \qquad ( 3 )$$

Here, d is the characteristic dimension of the effective spot 7 being rastered, and α is the thermal diffusivity of the material. Configuring process parameters to higher dimensionless ratios would act improve the fidelity of the approximated flux profile.

This approach is readily applicable to electromagnetic electron beam scanners, acousto-optic laser scanners, or electro-optic laser scanners which can raster back and forth at frequencies in the kilohertz range or higher. Mechanically based scanners, such as articulating mirror or prism configurations often used with lasers, are also available for operation in this range.

FIG. 7, shows a schematic representation of another exemplary apparatus for precision thermal processing of a workpiece 6. In this embodiment the energy beam 3 is a laser beam 44. In this case, means 5 to condition the spot shape and flux profile includes an optical train configured to include at least one Diffractive Optical Element (DOE) 38. The DOE 38 is configured to condition the laser beam 43 from a circular cross section and Gaussian flux distribution as it exits the laser source 44, in this case through a fiber optic cable 25, so that it irradiates the surface of body 6 with a spot 7 of predetermined shape and flux profile, determined as described above.

In this case the means to scan includes mounting the DOE 38 and a reflecting mirror 23 to a movable stage 24, and mounting the workpiece, 6 in a rotating chuck 26, much like a lathe. Note that for more complex applications, or to eliminate the need for the rotating chuck, the movable stage 24 could be configured as a robot arm (not shown) with multiple degrees of freedom.

While such an arrangement is useful for applications including surface heat treatment, the embodiment is further configured with an optional supply system 31 for unconsolidated material 21, in this case in powder form. The supply system 31 illustrated here entrains the unconsolidated material 21 in a stream of shield gas that is directed through a nozzle 45 mounted to the movable stage 24 to a location within the spot 7, where it is consolidated with the remainder of the body 6, enabling use of the overall apparatus as a laser cladding system for additive manufacturing or repair.

This embodiment serves to illustrate a class of embodiments wherein the body 6 includes a portion of material that is not yet consolidated 21, or is in the process of being consolidated to the remainder of the body, further comprising a supply system for the unconsolidated material 21 whereby at least a portion of the unconsolidated material 21 enters the domain in the vicinity of the spot 7 where it is heated and consolidated by the energy beam 3, thereby building up the body in an additive manufacturing or repair application.

Many types of supply systems for unconsolidated material 21 with application to additive manufacturing are known to the art and could similarly be integrated with the apparatus for precision heating of a body described herein without restriction. This includes, but is not restricted to systems that utilize feedstocks in powder, wire, or filament form. For powder feedstock, both powder jet and powder bed technologies are applicable with their corresponding powder supply systems. Exemplary references describing such devices in further detail, including US patent or patent applications, can be found in the Information Disclosure Statement filed with this application and are incorporated by reference, including all drawings and descriptions thereof.

Inasmuch as in the process illustrated, the spot 7 is remote from any local geometric features, and the body 6 is large compared to the spot size, a single DOE 38 of fixed optical properties is useful for a substantially steady-state thermal processing configuration where the required flux profile shape within the moving spot is not required to vary with time during the process, though the power of the beam 3 could optionally be varied to ensure a uniform local thermal process as the body 6 heats up in accordance with a schedule determined from a process simulation as described earlier. The DOE in FIG. 7 is shown configured to both focus the beam 3 and condition the spot shape and the flux profile shape associated with laser beam 43, though elements that only condition the laser beam 43 are also available, and will be illustrated hereafter. Elements of either type are available commercially for common prior-art shapes and flux profiles, and can be ordered to custom prescribed flux profiles such as are described herein. Typically, they are configured to work at a predetermined wavelength, which must match that of the laser beam, 43.

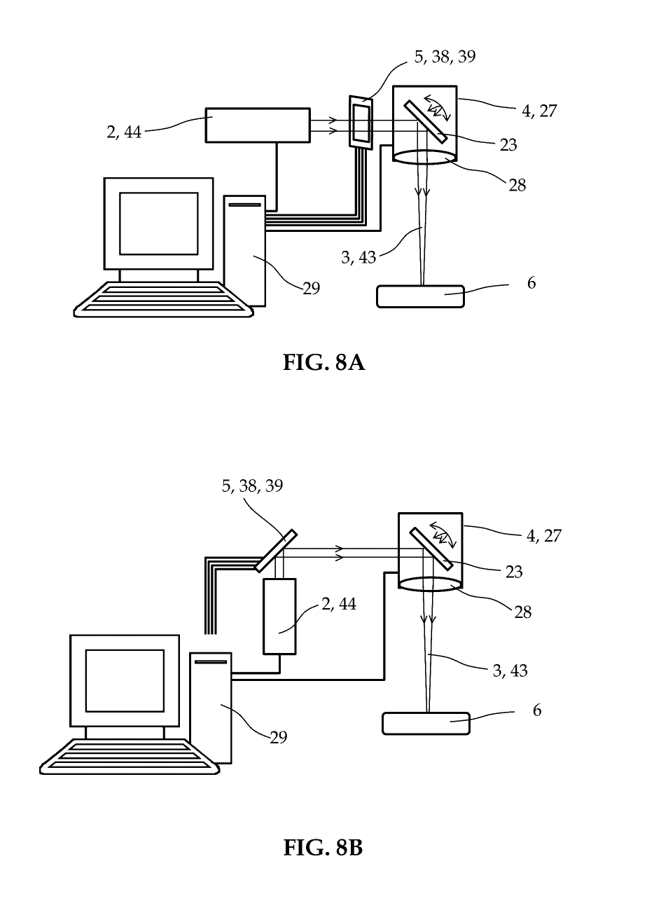

For more complex processes, it is useful to configure the apparatus with an adaptive DOE that can alter the flux profile dynamically. This is illustrated in FIGS. 8A and 8B using a Spatial Light Modulator (SLM) 39 as an adaptive DOE 38. An SLM is a device with individually addressable pixels which can be turned off or on to create a diffraction pattern. Available SLM devices are designed work in either transmission mode, as shown in FIG. 8A, or reflection mode, as shown in FIG. 8B. When a laser beam 43 is directed toward it, the screen can be programmed by way of an attached processor 29 to display a changeable diffraction pattern configured to condition the laser beam 43 to a dynamically changing flux profile shape. A scanner 27, here illustrated with a single movable mirror 23, and an F-theta lens 28 (though many types are available commercially) is likewise connected to the processor 29, and scans the workpiece 6 according to a predetermined path. The laser 44 is also connected to the processor 29, allowing it be programmed to vary the output power synchronously with the SLM 39 and scanner 27, thereby applying a flux profile history based on an a simulation of the process as described earlier.

Commercially available SLM devices available at this writing are currently limited to relatively low (albeit useful) optical power operation, but are expected to increase in capability over time as screens with larger active area are produced, and/or the permissible flux is increased.

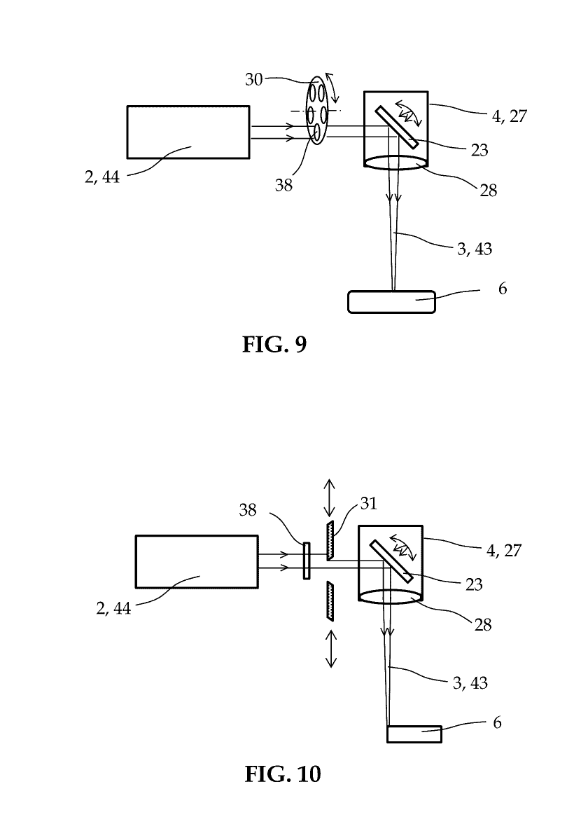

Another embodiment, illustrated in FIG. 9, is configured to include means 30, shown as a rotable wheel or turret, to switch elements selected from a mulitiplicity of DOE 38 into the optical train according to a predetermined schedule, thereby approximating dynamically changing flux profiles, or accommodating changes in operational parameters that affect the required flux profile.

Another adaptive DOE embodiment, illustrated in FIG. 10, includes a DOE with fixed optical properties. It is further configured with a moveable element 31 to occlude or filter a portion of the beam 3 by moving partially into its path. For example, a DOE designed to produce a full-symmetry flux profile such as is shown in FIGS. 2A-2C can be used but when passing by an edge 20, the beam 3 is partially truncated or occluded, yielding half-symmetry or intermediate flux profiles similar to those shown in FIG. 4, and FIGS. 5A-5B.

Further, in some applications instead of using a fully opaque element, the movable element 31 may be a filtering element. Also, more than one element may be used as shown in the figure; for example, two occluding elements 31 opposite each other, occluding the beam 3 from either side, or from two sides at once, such as might be appropriate for thermally processing the surface on top of a thin wall.

Note that in the limit of high dimensionless spot velocities as the spot profile becomes largely 2D in nature as illustrated in FIG. 2D, the proximity to an edge is of less concern with regard to the shape of the flux profile.

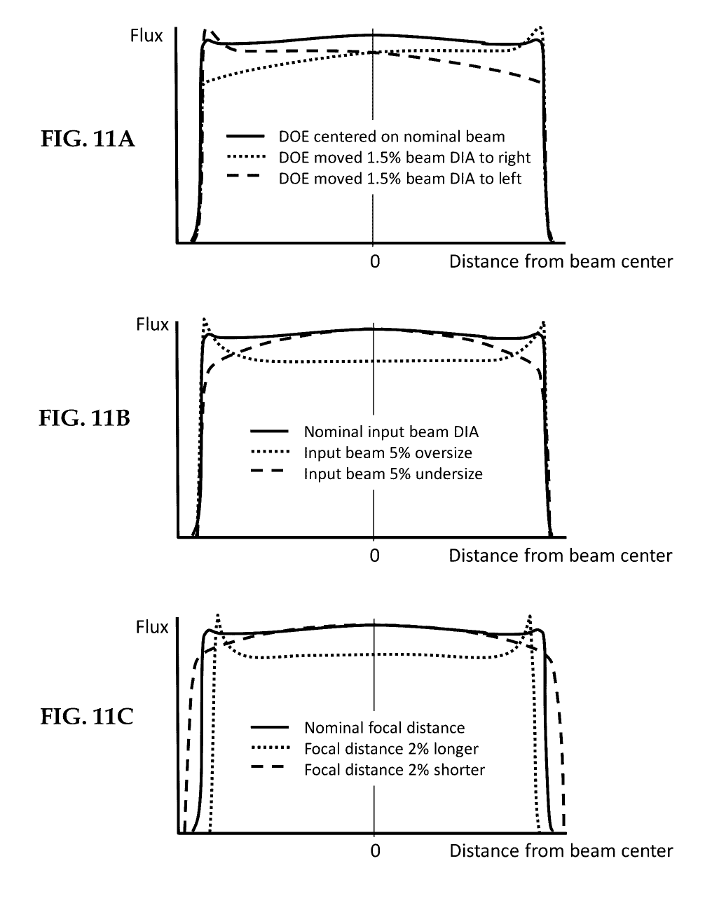

In FIGS. 11A-C, the flux profile of a spot created by a DOE designed to produce a flat-top profile is depicted, illustrating the effects of various deviations from the nominal operating conditions associated with the nominal flat-top flux profile. In the nominal operating condition, the DOE location is centered on the beam, and the input beam has a specified nominal beam diameter. For DOE's configured to both focus and shape the beam, such as the one depicted in FIG. 7, the focal distance from DOE to the surface of the workpiece also has a nominal value. Flat DOE's designed to work with an F-theta scanning lens (as shown in FIG. 8 and up) are not sensitive to the focal length.

DOE suppliers provide charts like this to caution users to carefully align the beam and the DOE and use the nominal beam diameter within close tolerance to ensure the intended (flat-top) performance with minimal variation. However, as will be shown, by intentionally providing means to articulate the DOE with respect to the nominal position, and means to alter the input beam diameter with respect to the nominal input diameter such variations from the nominal performance can be put to good use.

FIG. 11A illustrates the effect of moving the DOE away from the centerline of the optical path, showing that the flux profile becomes asymmetric when this done, and develops maximum flux at a cusp on the side corresponding to the direction of movement.

FIG. 11B illustrates the effect of changing the input beam diameter to a non-nominal value. In this case the flux profile remains symmetric, but shows that the flux profile becomes concave with cusps on both sides when the input beam is oversized, and convex when undersized.

A similar effect, shown in FIG. 11C, occurs with a deviation in applied focal distance for a DOE configured to both focus and shape the beam.

It is apparent that even a standard, rectangular flat-topped DOE can be coaxed into flux profiles approximating those shown in FIGS. 2B and 2C by judiciously oversizing the input beam and moving the DOE off-center toward the side of the beam corresponding to the leading edge of the spot. By further offsetting the DOE to the side or otherwise, flux profiles associated with operation along edges or near other geometric features can be approximated.

By further optimizing the DOE configuration, it is possible to obtain even better approximations of flux patterns required for a specific application, or even for a wide range of applications. For a given DOE configuration, the corresponding flux profile shapes for a wide range of offsets and input beam diameters can be predicted using optical theory by one skilled in the art.

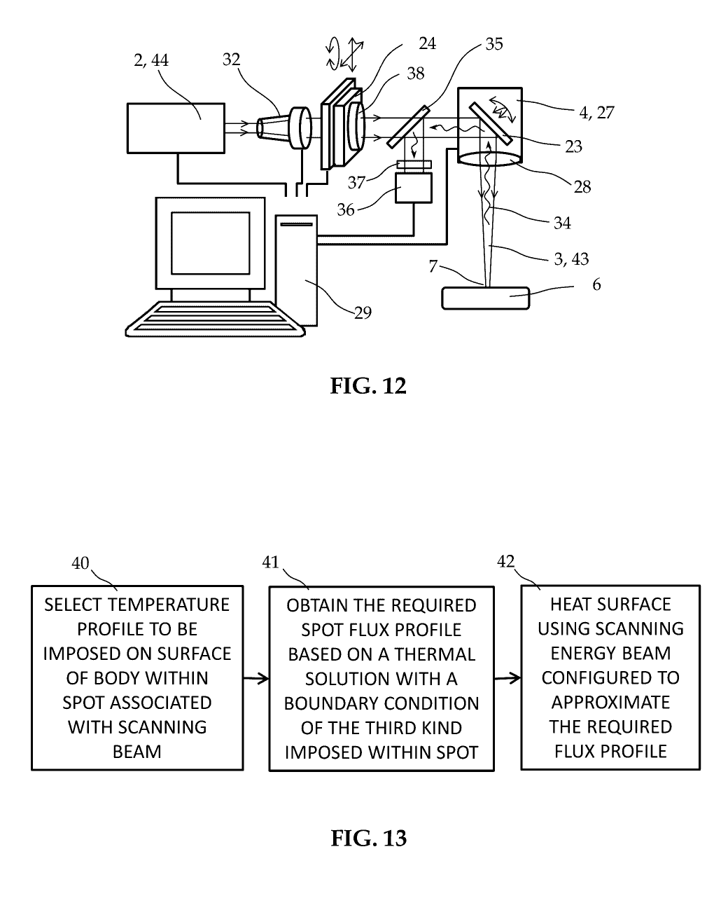

This concept is embodied in FIG. 12, where a DOE 38 of fixed optical properties is mounted on a movable stage 24 with two translational degrees of freedom normal to the optical axis, and a rotational degree of freedom about the optical axis (an x-y-theta stage). A variable beam expander 32 is also shown, allowing the input beam diameter to the DOE 38 to be varied. The shape of the flux profile is adjusted by translating the DOE 38 with the moving stage 24, and adjusting the beam diameter with the beam expander 32. The orientation of the spot 7 is rotated by rotating the DOE 38 to match the scanning direction effected by the scanner 27. These devices, in addition to the laser source 44, are connected to a processor 29, which is programmed to coordinate the resulting dynamic flux profile and scan path to match a predetermined process sequence.

As described earlier, it is useful to determine the target process sequence from a simulation of the entire thermal process with a third-kind boundary condition imposed on the spot 7 throughout the process. The results of the simulation, including the sequence of flux profiles, and the corresponding instructions for the laser 44, variable beam expander 32, movable stage 24, and scanner 27, throughout the duration of the process can all be calculated and stored electronically for repeated use.

Also shown in FIG. 12 is an optional thermal monitoring arrangement common to the art. Infrared radiation 34 emitted from the spot surface is reflected back through the scanner 27, and again selectively reflected by a partially reflective mirror 35, through a filter 37 configured to omit any stray laser light, finally arriving at a temperature sensor 36 such as a pyrometer or infrared camera. While this information can be used merely for process monitoring and certification, it is also useful in sensitive processes to adjust the laser power output in either open or closed loop control to bring the temperature closer to a specified value, thus correcting for variations in the material thermal properties or other process variables.

The stability of the temperature measurement may also be enhanced by configuring the sensor 36 to measure the average temperature over a portion of the spot 7 that is configured to be nominally at constant temperature where applicable.

Many potential uses for the heating apparatus and method are thus encompassed in the present invention which include, but are not limited to those mentioned above.

In addition to the apparatus described above and hereafter, the invention encompasses the method for precision thermal processing of a body described herein, and outlined in FIG. 13. In summary, the process includes first, selecting 40 a predetermined surface temperature profile to impose on the surface of the body within a moving, locally heated spot of predetermined shape and size, which scans the surface of the body as it is being thermally processed; second, obtaining 41 the required flux profile within the spot to achieve the predetermined surface temperature profile as the spot moves across the surface of the body from the solution of a thermal problem representing the body with a boundary condition of the third kind imposed within the spot; and third, heating 42 the surface with the energy beam, wherein the beam is configured to the spot shape and flux profile as it scans across the surface of said body.

Further, variants of the process include use of all embodiments as described.

As can be seen, many other useful embodiments and applications of the precision thermal processing technology described could be devised by one with ordinary skill in the art.

Many potential uses for the apparatus and method for precision thermal processing of a body are thus encompassed in the present invention. Potential uses include any application which would benefit from the ability to apply a prescribed uniform or variable thermal process to the surface of a body, thus including but not limited to thermal processing of inorganic materials, such as metals and ceramics, and thermal processing of polymeric or organic materials or tissues. Exemplary desired outcomes may range from an improvement of surface properties, such as hardness or wear resistance, to the fabrication of a component through an additive manufacturing process, including production and repair of single crystal parts such as turbine blades.

Although the present invention has been described in considerable detail with reference to certain preferred versions thereof, alternate configurations and arrangements can be easily devised by one skilled in the art. Therefore, the spirit and scope of the appended claims should not be limited to the description of the preferred versions contained herein. The reader's attention is directed to all papers and documents which are filed concurrently with this specification and which are open to public inspection with this specification, and the contents of all such papers and documents are incorporated herein by reference. All the features disclosed in this specification (including any accompanying claims, abstract, and drawings) may be replaced by alternative features serving the same, equivalent or similar purpose, unless expressly stated otherwise. Thus, unless expressly stated otherwise, each feature disclosed is one example only of a generic series of equivalent or similar features.

### LIST OF REFERENCE SYMBOLS

1 Apparatus for controlled heating of a body
2 Energy beam source
3 Energy beam
4 Means to scan beam across surface of body
5 Means to condition spot shape and flux profile
6 Body or workpiece
7 Spot instantaneously or quasi-instantaneously irradiated by energy beam
7 Specified temperature profile within spot (associated with thermal boundary condition of the third kind)
9 Region within spot specified to be held at a constant temperature (spatial representation)
10 Temperature ramp within spot (spatial representation)
11 Flux distribution obtained from thermal solution with boundary condition of the third kind, and imposed approximately within spot
12 Temperature vs time profile of surface as spot is scanned over it
13 Region within spot specified to be held at a constant temperature (temporal representation)
14 Temperature ramp within spot (temporal representation)
15 Example of locally periodic flux distribution
16 Region of local maximum flux
17 Region of local minimum flux
18 Region of local minimum temperature
19 Nonlinear dendrite growth
20 Edge
21 Unconsolidated material
22 Raster path within spot
23 Mirror
24 Movable stage
25 Fiber optic cable
26 Rotating chuck
27 Scanning unit
28 F-Theta lens
29 Processor or computer
30 Turret for moving optical elements in and out of optical path
31 Supply system for unconsolidated material
32 Variable beam expander
33 Thin layer of unconsolidated material
34 Infrared signal emanating from heated spot surface
35 Window with selective reflectivity
36 Infrared sensor or camera
37 Light filter
38 Diffractive Optic Element (DOE)
39 Spatial Light Modulator (SLM)
40 Step of temperature profile selection
41 Step of obtaining flux profile from thermal solution with boundary condition of the third kind imposed within spot
42 Step of heating the surface with the scanning energy beam
43 Laser Beam
44 Laser Beam Source
45 Nozzle

The invention claimed is:

1. An apparatus for precision thermal processing of a body, comprising:
(a) an energy beam emanating from a beam source; and
(b) means to scan said energy beam across the surface of said body, thereby creating heat input through a moving spot on the surface of said body; and
(c) means to condition the spot shape and flux profile, wherein said flux profile within said spot is configured to approximate a thermal solution obtained by solving a boundary condition of the third kind imposed upon the moving spot associated with said beam as it is scanned across said body.

2. The apparatus according to claim 1 wherein said spot shape is configured to be rectangular, and wherein said means to scan is configured to move said spot along an axis substantially parallel to one of its edges as said beam scans across said body.

3. The apparatus according to claim 2 wherein the specified surface temperature profile within said spot corresponding to said boundary condition of the third kind is constant along the direction normal to said axis of movement, thereby imparting substantially the same temperature vs time profile to each point within a set of surface points entering the leading edge of the spot simultaneously, within the time interval while the spot passes over them.

4. The apparatus according to claim 3 wherein said means to scan is configured to move the spot at a substantially constant velocity, and said surface temperature profile within the spot is specified to be time-independent, thereby applying said substantially uniform temperature vs time profile to that portion of the surface so treated.

5. The apparatus of claim 4, wherein said temperature profile within said spot is configured to substantially include one or more of the following:
(a) a region held at a constant predetermined temperature,
(b) a temperature ramp, wherein the temperature changes at a predetermined rate.

6. The apparatus of claim 2, wherein:
(a) said flux profile is further configured by superposing upon it a substantially periodic flux pattern of substantially zero net flux, thereby creating a periodic flux locally, while substantially retaining the original character of said flux profile macroscopically; and
(b) said periodic flux pattern is configured to have a period length of a scale comparable in magnitude to the expected primary dendrite spacing of the processed material.

7. The apparatus of claim 1, wherein said means to condition the spot shape and size is integrated with said means to scan, wherein said beam rasters out an effective spot shape and flux distribution at high speed, and said effective spot moves over the surface at low speed.

8. The apparatus according to claim 1 wherein said means to condition the spot shape and flux profile includes an optical train configured to include at least one diffractive optical element.

9. The apparatus according to claim 1 wherein said body includes a portion of material that is not yet consolidated, or is in the process of being consolidated to the remainder of the body, further comprising a supply system for the unconsolidated material whereby at least a portion of said material enters the spot domain where it is heated and consolidated by said beam, thereby building up the body in an additive manufacturing or repair application.

10. The apparatus of claim 8, wherein said at least one diffractive optical element includes a spatial light modulator programmed to display a changeable diffractive pattern, configured to condition the beam to a changeable flux profile, thereby approximating dynamically changing flux profiles, or accommodating changes in operational parameters that affect the flux profile.

11. The apparatus of claim 8, wherein:
(a) said at least one diffractive optical element comprises a multiplicity of diffractive optical elements, each configured to condition said beam to a predetermined spot flux distribution; and
(b) said optical train is further configured to include means to switch elements selected from said mulitiplicity of diffractive optical elements into said optical train according to a predetermined schedule, thereby approximating dynamically changing flux profiles, or accommodating changes in operational parameters that affect the flux profile.

12. The apparatus of claim 8, wherein said at least one diffractive optical element includes an element with fixed optical properties, further comprising a movable element to occlude or filter a portion of said beam by moving partially into its path, thereby approximating changes in said flux distribution as said beam scans along the surface of said body in the vicinity of an edge or other feature.

13. The apparatus of claim 8, wherein said at least one diffractive optical element includes an element with fixed optical properties, designed to produce a predetermined spot flux profile when said element is placed at a nominal location within the optical train, and said beam has a nominal input diameter where it enters said element, further comprising:
(a) means to articulate said element with respect to said nominal position; and
(b) means to alter the input beam diameter with respect to said nominal input diameter; whereby variations in said spot flux profile are created, wherein the range of said variations is configured to approximate said thermal solutions.

14. The apparatus of claim 3, further comprising a temperature sensor and feedback system configured to control the surface temperature within a portion of said spot by adjusting the total beam power, thereby holding the measured temperature to a predetermined value, or sequence of values.

15. A process for precision thermal processing of a body with an energy beam, comprising:
(a) selecting a predetermined surface temperature profile to impose on the surface of said body within a moving, locally heated spot of predetermined shape and size, associated with said beam as it scans the surface of said body to apply a thermal process thereto; and
(b) obtaining the required flux profile within said spot to achieve said predetermined surface temperature profile as said spot moves across the surface of said body from the solution of a thermal problem representing said body with a boundary condition of the third kind imposed within said spot; and
(c) heating the surface with said energy beam, wherein said beam is configured to approximate said spot shape and said flux profile as it scans across the surface of said body.

16. The process of claim 15, wherein said body includes a portion of material that is not yet consolidated, or is in the process of being consolidated to the remainder of the body, as in an additive manufacturing process.

17. The process of claim 15, wherein a portion of said body is substantially of a single crystal, and said material being consolidated is being consolidated epitaxially thereto, thereby repairing or manufacturing a single crystal part.

18. The process of claim 15, wherein:
(a) said spot shape is configured to be rectangular; and
(b) said spot moves along an axis substantially parallel to one of its edges as said beam scans across said body; and
(c) said predetermined temperature profile is constant along the direction normal to said axis of movement, thereby imparting substantially the same temperature vs time profile to a set of surface points entering the leading edge of the spot simultaneously, within the time interval while the spot passes over them.

19. The process of claim 14, wherein said temperature profile within said spot is configured to substantially include one or more of the following:
(a) a dwell period at predetermined temperature,
(b) a temperature ramp, where the temperature changes at a predetermined rate.

20. A diffractive optical element configured to condition a laser beam of a predetermined wavelength to produce a moving spot having rectangular shape and a flux profile as said beam scans over the surface of said body, wherein:
(a) said flux profile within said spot is configured to approximate a thermal solution associated with a boundary condition of the third kind imposed upon the surface of said body within the domain of said moving spot; and
(b) said boundary condition of the third kind corresponds to a temperature profile within said spot configured to substantially include one or more of the following:
(i) a dwell period at predetermined temperature,
(ii) a temperature ramp, where the temperature changes at a predetermined rate.
